(19) United States
(12) Patent Application Publication
(10) Pub. No.: US 2006/0192735 A1
(43) Pub. Date: Aug. 31, 2006

(54) Information processing apparatus and display apparatus

(76) Inventor: Toshikazu Morisawa, Tokorozawa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/357,648

(22) Filed: Feb. 17, 2006

(30) Foreign Application Priority Data
Feb. 28, 2005 (JP) 2005-054274

(51) Int. Cl. G09G 3/36

(52) U.S. Cl. 345/87

(57) ABSTRACT

According to one embodiment, there is provided an information processing apparatus including a display having a deviation filter formed by a right deviation filter which blocks and transmits a light from a predetermined direction and a left deviation member which blocks and transmits a light from a direction different from the predetermined direction, such that the deviation members are arranged in a one-to-one correspondence with respective pixels of the liquid crystal display, a display controller which controls display of the liquid crystal display, a block/transmission filter control section which controls light block and transmission of the deviation filter, a right deviation filter buffer, a left deviation filter buffer, and a real display buffer which temporarily stores display information stored in the buffers and transmits the display information to the display controller as display information.

### CROSS-REFERENCE TO RELATED APPLICATIONS

This application is based upon and claims the benefit of priority from Japanese Patent Application No. 2005-054274, filed Feb. 28, 2005, the entire contents of which are incorporated herein by reference.

### BACKGROUND

1. Field

One embodiment of the invention relates to a display apparatus which displays information such as output images of a computer and a television, and an information processing apparatus having the display apparatus. In particular, the present invention relates to an information processing apparatus and a display apparatus which display single or a plurality of image information items on one screen, and can display different display contents with display regions divided, according to relative positions with respect to the display apparatus.

2. Description of the Related Art

As a display apparatus, prior Art of the present invention discloses a technique of displaying a single or a plurality of image information items on one screen of an LCD apparatus, and displaying different display contents with display regions divided, according to relative positions with respect to the display apparatus. In this technique, a common LCD apparatus which is viewed from the front is used Jpn. Pat. Appln. KOKAI Publication No. 2000-206483. It can be viewed from the left and the right of the apparatus, by physically covering the surface of the LCD apparatus with a special lenticular board (lens-equipped deviation board).

However, the above technique has the problem that a lenticular board has to be physically attached or detached each time, according to the use of the apparatus, e.g., the cases where the apparatus is viewed from the front, and the cases where the apparatus is viewed from the left and the right. Attachment and detachment of the lenticular board incurs a physical attaching/detaching mechanism, and increases the manufacturing cost of the apparatus. Further, a physical thickness of the attaching/detaching mechanism for the lenticular board increases the thickness and the weight of the LCD apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view illustrating a notebook tablet PC being an information processing apparatus according to a first embodiment of the invention.

FIG. 2 is a perspective view illustrating a tablet style state of the notebook tablet PC being the information processing apparatus according to the first embodiment.

FIG. 3 is a schematic diagram illustrating a case where two users facing each other view a display according to the first embodiment.

FIG. 4 is a schematic diagram illustrating a method of displaying different images on the display according to the first embodiment.

FIG. 5 is a conceptual diagram illustrating structures of deviation filters according to the first embodiment.

FIG. 6 is a schematic diagram illustrating a state of images displayed on the display in the case where the deviation filters according to the first embodiment of the present invention are arranged in a striped pattern arrangement.

FIG. 7 is a schematic diagram illustrating a state of images displayed on the display in the case where the deviation filters according to the first embodiment are arranged in a checkered pattern arrangement.

FIG. 8 is a functional block diagram illustrating a configuration of the tablet PC being the information processing apparatus according to the first embodiment.

FIG. 9 is a flowchart illustrating a driver processing procedure of a display controller after a display (drawing) request from an application program, according to the first embodiment.

FIG. 10 is a flowchart illustrating processing executed by the driver when the double-vision display switching control is performed according to the first embodiment.

FIG. 11 is a functional block diagram illustrating a configuration of a tablet PC being an information processing apparatus according to a second embodiment of the invention.

### DETAILED DESCRIPTION

Various embodiments according to the invention will be described hereinafter with reference to the accompanying drawings. In general, according to one embodiment of the invention, an information processing apparatus comprises: a display device including a liquid crystal display layer which decomposes an image into a plurality of pixel data, displays the image on a display screen as a group of pixel data, and outputs pixel data forming one display image and pixel data forming another display image in a specific arrangement on the same display screen as images, and a filter layer disposed on a display side of the liquid crystal display layer and formed by alternately arranging a first filter member which blocks and transmits a light from a predetermined direction and a second filter member which blocks and transmits a light from a direction different from the predetermined direction, such that the filter members are arranged in a one-to-one correspondence with respective pixels of the liquid crystal display layer; a display controller which controls display of the liquid crystal display layer; filter control means for controlling light block and transmission of the filter layer; a first filter memory which stores display information to be displayed by pixels corresponding to the first filter member; a second filter memory which stores display information to be displayed by pixels corresponding to the second filter member; and a video memory which temporarily stores the display information stored in the first filter memory and the display information stored in the second filter memory, and send the display information to the display controller as display information.

Therefore, it is possible to electrically switch light transmission directions of an LCD (liquid crystal display) apparatus.

By using the present invention, it is possible to provide an information processing apparatus and a display apparatus which electrically switch light transmission directions of an LCD apparatus.

### First Embodiment

Embodiments of the present invention will be explained below with reference to drawings.

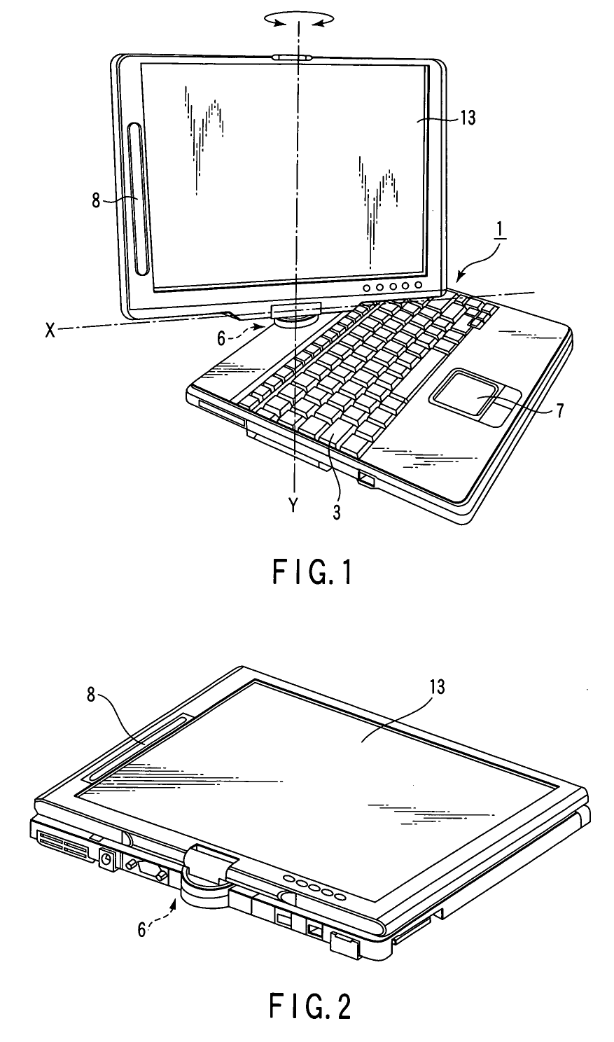

FIG. 1 is a perspective view illustrating a notebook tablet PC being an information processing apparatus according to a first embodiment of the present invention.

A tablet PC 1 comprises a main body, which includes a keyboard 3, a touch pad 7, and a hinge portion 6 serving as a connecting portion to a movable liquid crystal display 13, and the display 13 which is movably connected to the hinge portion 6. In the tablet PC 1, the display 13 is a touch panel, and allows direct operation to the display 13 by a stylus 8 and the like.

The display 13 is rotatable around a Y axis with the hinge portion 6 used as a pivot. Further, the display 13 can be folded down with an X axis used as an axis of rotation. For example, if the display 13 is folded down with a display surface of the display 13 upward, the tablet PC 1 turns into a tablet style as shown in FIG. 2. The tablet style is applicable to cases where two users view the display 13, for example.

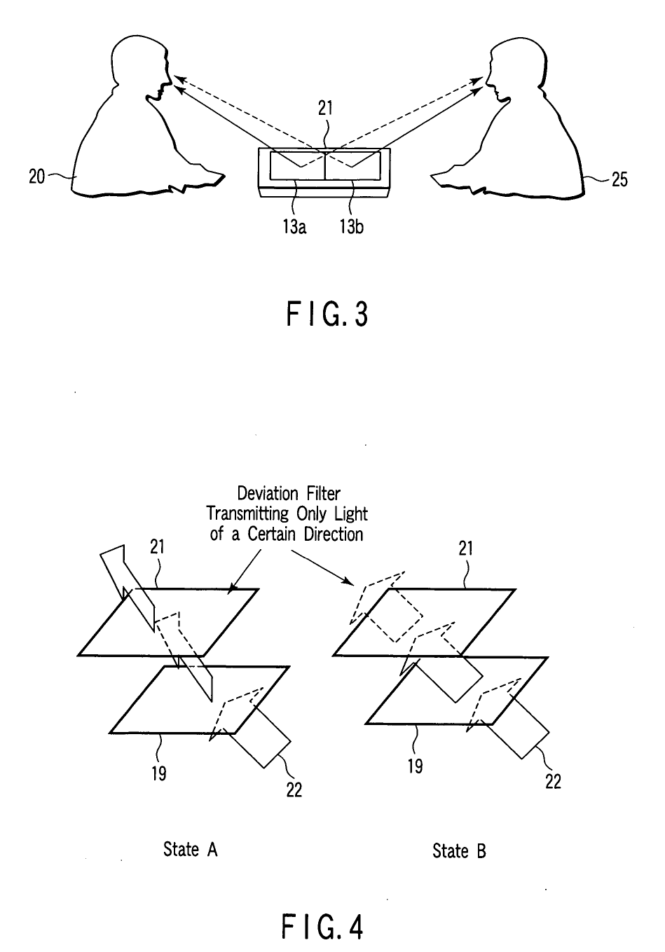

As shown in FIG. 3, if users 20 and 25 view the display 13, it is possible to display different images to the respective users 20 and 25. For example, if different images 13a and 13b are simultaneously displayed on the display 13, the users 20 and 25 can view respective images indicated by solid lines, and cannot view respective images indicated by broken lines.

FIG. 4 is a schematic diagram illustrating a method of displaying different images on the display 13.

The electrically switchable display 13 used in the present invention has a structure in which a deviation filter 21 is superposed on a normal liquid crystal layer 19. In the display 13 having this structure, when voltage is not applied to the display 13, that is, in state A, the direction of light 22 is changed by the deviation filter 21, and thereby the light 22 transmits through the deviation filter 21. If voltage is applied to the display 13, that is, in state B, the direction of the light 22 is not changed by the deviation filter 21, and thus the light 22 is blocked by the deviation filter 21. In such a manner, light can be transmitted and blocked by turning on and off the voltage.

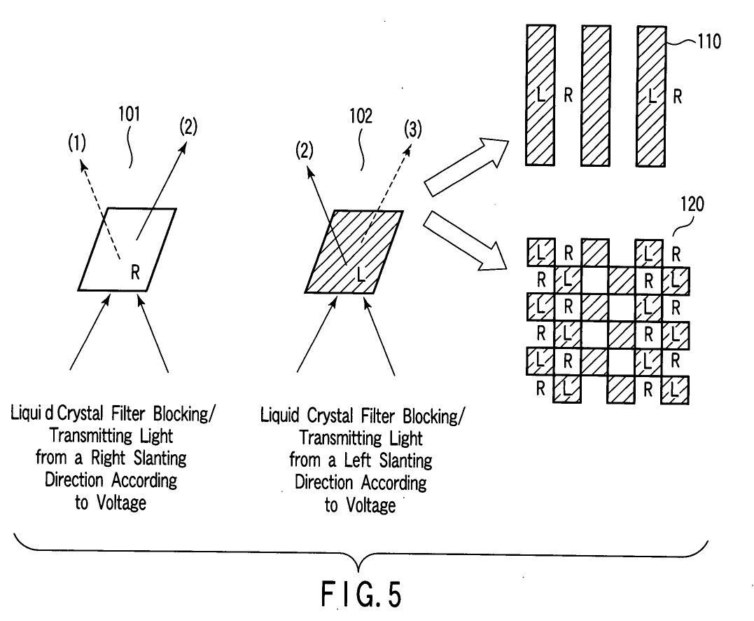

FIG. 5 illustrates the deviation filter 21 using the above method. A deviation filter R101 transmits or blocks light (1) from a right slanting direction according to the voltage (it always transmits light (2) from a left slanting direction). A deviation filter L102 transmits or blocks light (4) from a left slanting direction according to the voltage (it always transmits light (3) from a right slanting direction). These deviation filters are provided in a striped pattern arrangement 110 or a checkered pattern arrangement 120.

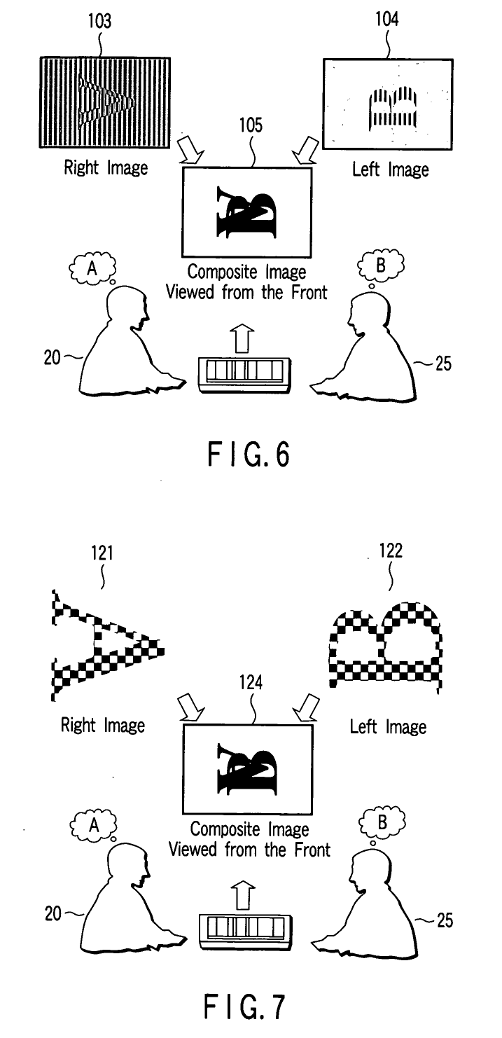

FIG. 6 is a schematic diagram illustrating states of images displayed on the display 13 when the deviation filter is formed with the striped pattern arrangement 110. An image (the light (1) from the right slanting direction) transmitted through the deviation filter R101 on the display 13 serves as a right image “A” 103, and is viewed by the user 20 as the character “A”. In the meantime, an image (the light (4) from the left slanting direction) transmitted through the deviation filter L102 on the display 13 serves as a left image “B” 104, and viewed by the user 25 as the character “B”. Further, when the display 13 is viewed from the front, a composite image 105 being a combination of the right image “A” 103 and the left image “B” 104 is viewed, since in the front portion the light (2) from the left slanting direction is transmitted through the deviation filter R101 and the light (3) from the right slanting direction is transmitted through the deviation filter L102.

FIG. 7 is a schematic diagram illustrating states of images displayed on the display 13 when the deviation filter is formed with the checkered pattern arrangement. An image (the light (1) from the right slanting direction) transmitted through the deviation filter R101 on the display 13 serves as a right image “A” 121, and is viewed by the user 20 as the character “A”. In the meantime, an image (the light (4) from the left slanting direction) transmitted through the deviation filter L102 on the display 13 serves as a left image “B” 122, and viewed by the user 25 as the character “B”. Further, when the display 13 is viewed from the front, a composite image 124 being a combination of the right image “A” 121 and the left image “B” 122 is viewed, since in the front portion the light (2) from the left slanting direction is transmitted through the deviation filter R101 and the light (3) from the right slanting direction is transmitted through the deviation filter L102. The deviation filter formed with the checkered pattern arrangement 120 enables a finer image display than in the case of adopting the striped pattern arrangement 110.

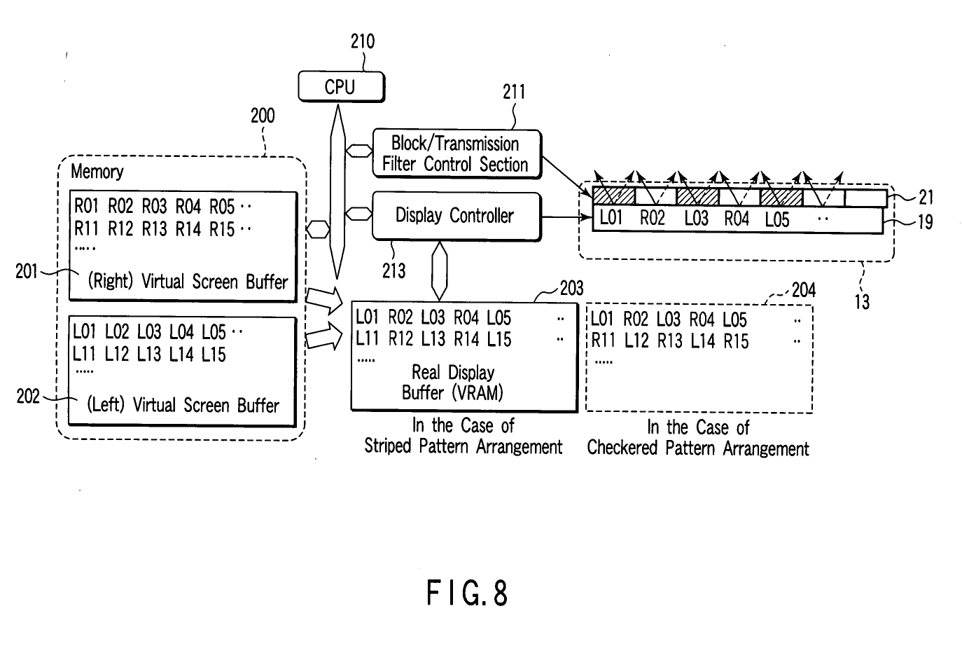

FIG. 8 is a functional block diagram illustrating a configuration of the tablet PC being the information processing apparatus of the present invention.

The tablet PC 1 comprises a CPU 210 for controlling the tablet PC 1, the display 13 formed of the liquid crystal layer 19 and the deviation filter 21, a block/transmission filter control section 211 which controls block and transmission of light of the deviation filter 21, a display controller 213 which controls image display of the liquid crystal layer 19, a real display buffer (VRAM) 203 (or 204) being a video memory which temporarily stores image data to be displayed on the display 13, a right virtual screen buffer 201 being a video memory which temporarily stores image data to be displayed by pixels of the liquid crystal layer 19 corresponding to the deviation filter R101, and sends the stored image data to the real display buffer (VRAM) 203, 204, and a left virtual screen buffer 202 being a video memory which temporarily stores image data to be displayed by pixels of the liquid crystal layer 19 corresponding to the deviation filter L102, and sends the stored image data to the real display buffer (VRAM) 203, 204.

It is unnecessary to provide both the real display buffers (VRAM) 203 and 204. If the striped pattern arrangement is adopted, a striped pattern deviation filter is used as the deviation filter 21 and the real display buffer (VRAM) 203 is used. If the checkered pattern arrangement is adopted, a checkered pattern deviation filter is used as the deviation filter 21 and the real display buffer (VRAM) 204 is used.

Operation of the tablet PC 1 having the above structure is explained.

If the display switches to a double-vision mode, pixel data of the right virtual screen buffer 201 and pixel data of the left virtual screen buffer 202 are alternately transferred to (arranged in) the real display buffer 203.

In this operation, the transfer (arrangement) method differs according to whether the deviation filter 21 has the striped pattern arrangement or the checkered pattern arrangement. In the case of the striped pattern arrangement, lines of the right pixel data are arranged alternately with lines of the left pixel data. In the case of the checkered pattern arrangement, the buffer 203 has alternate pixel data lines of left-and-right arrangement in which left pixel data and right pixel data alternate in this order and right-and-left arrangement in which right pixel data and left pixel data alternate in this order.

The data stored in the real display buffer 203 is read by the display controller 213 and transmitted to the display 13 as an image signal. In this operation, if a block mode is set in the block/transmission filter control section 211, the deviation filter 21 having the striped pattern arrangement (or the checkered pattern arrangement) blocks the right slanting light or the left slanting light to provide a pixel skipping display state, and enables viewing of different images according to the viewing angle. In a normal use in which no double-vision display is performed, the pixel data stored in the right virtual screen buffer 201 or the left virtual screen buffer 202 are transferred to the real display buffer 203 in their original order. In this case, the block/transmission filter control section 211 is placed in a transmission mode, and thereby does not perform block light of a specific angle, but enables the users to view the same image from the right and the left of the display.

The block/transmission filter control section 11 can be incorporated into the display controller 213.

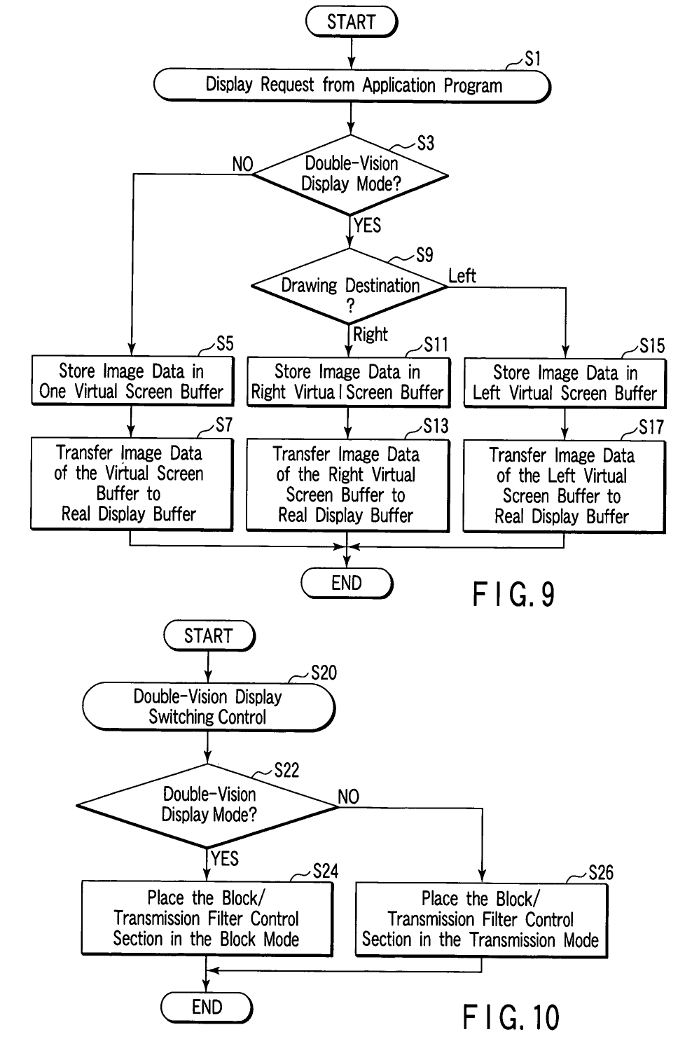

FIG. 9 is a flowchart illustrating a processing procedure of a driver of the display controller 213 after it receives a display (drawing) request from an application program.

When the driver receives a display request from an application program in step S1, the driver determines in step S2 whether the apparatus is in the double-vision display mode or not. If the driver determines that the apparatus is in the double-vision display mode in step S2, the driver determines the drawing destination of the drawing (display) request in step S9. If the driver determines in step S9 that the drawing destination of the drawing request is the right virtual screen, the driver stores the image data of the drawing request in the right virtual screen buffer, and transfers the image data of the right virtual screen buffer to the real display buffer in step S13.

In the meantime, if the driver determines in step S9 that the drawing destination of the drawing request is the left virtual screen, the driver stores the image data of the drawing request in the left virtual screen buffer, and transfers the image data of the left virtual screen buffer to the real display buffer in step S17.

Further, if the drivers determines in step S3 that the apparatus is not in the double-vision display mode, the display controller 213 stores the image data of the drawing request in one of the virtual screen buffers (for example, the right virtual screen buffer 201) and, transfers the image data of the right virtual screen buffer 201 to the real display buffer 203 without inserting intervals between the image data in step S7.

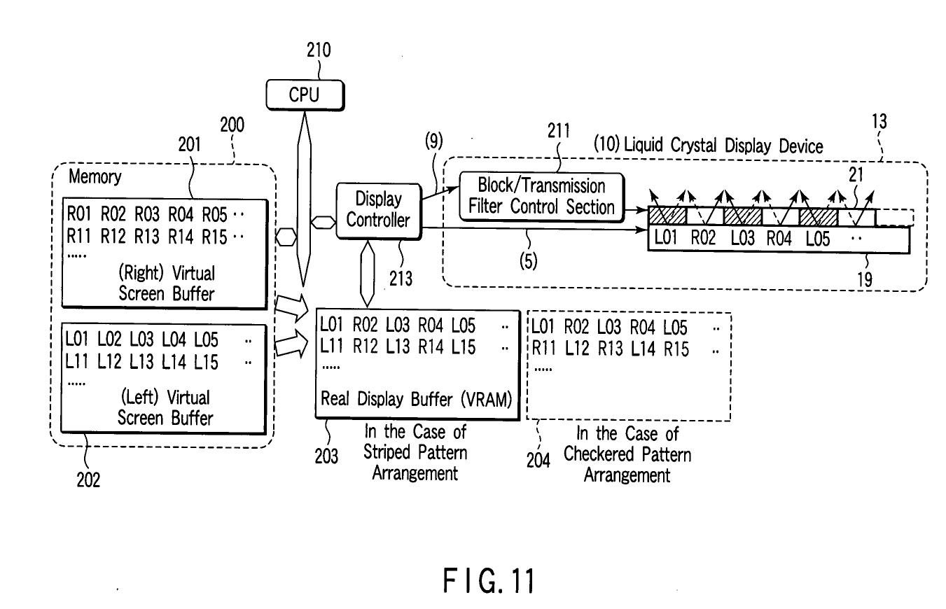

Next, FIG. 10 is a flowchart illustrating processing executed by the driver when the double-vision display switching control is performed.

In step S20, the display controller 213 proceeds to a double-vision display switching control mode. In step S22, the display controller 213 determines whether a requested display mode is the double-vision display mode or not. If the mode is the double-vision display mode in step S22, the display controller 213 places the block/transmission filter control section 211 in the block mode in step S24. In the meantime, if the mode is not the double-vision display mode (normal display mode) in step S22, the display controller 213 places the block/transmission filter control section 211 in the transmission mode in step S26.

By the above processing, it is possible to electrically switch the light transmission directions of the LCD apparatus, and the users can view respective different images on one liquid crystal display from predetermined two directions.

### Second Embodiment

Next, a second embodiment of the present invention is explained with reference to FIG. 11.

The same constituent elements as those in the first embodiment are denoted by the same respective reference numerals as in the first embodiment, and detailed explanations thereof are omitted. The second embodiment of the present invention is different from the first embodiment in that a block/transmission filter control section 211 is incorporated into a display 13.

FIG. 11 illustrates a case where a liquid crystal display device (display 13) having a block/transmission filter control section 211 and a deviation filter 21 is connected by a cable to a personal computer. The cable includes at least an image signal transfer section (5) and a block/transmission signal transfer section (9).

According to the above structure, the present invention is realized by a combination of the display apparatus (liquid crystal display) described in the second embodiment and a common personal computer, with dedicated display control software installed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display device including a liquid crystal display layer which decomposes an image into a plurality of pixel data, displays the image on a display screen as a group of pixel data, and outputs pixel data forming one display image and pixel data forming another display image in a specific arrangement on the same display screen as images, and a filter layer disposed on a display side of the liquid crystal display layer and formed by alternately arranging a first filter member which blocks and transmits a light from a predetermined direction and a second filter member which blocks and transmits a light from a direction different from the predetermined direction, such that the filter members are arranged in a one-to-one correspondence with respective pixels of the liquid crystal display layer;
a display controller which controls display of the liquid crystal display layer;
filter control means for controlling light block and transmission of the filter layer;
a first filter memory which stores display information to be displayed by pixels corresponding to the first filter member;
a second filter memory which stores display information to be displayed by pixels corresponding to the second filter member; and
a video memory which temporarily stores the display information stored in the first filter memory and the display information stored in the second filter memory, and send the display information to the display controller as display information.

2. An information processing apparatus according to claim 1, wherein the direction different from the predetermined direction is a direction having a plane symmetry relationship with the predetermined direction.

3. An information processing apparatus according to claim 1, wherein the filter control means controls light block and transmission by applying a charge to the filter layer, and the display controller performs a control to display the respective images by the pixels corresponding to the first filter member and the pixels corresponding to the second filter member.

4. An information processing apparatus according to claim 1, wherein the filter layer transmits light from all the directions to display all the information displayed by the pixels of the liquid crystal layer, by performing control not to apply a charge to the filter layer by the filter control means.

5. An information processing apparatus according to claim 1, wherein the display device is formed by alternating the first filter member and the second filter member in a striped pattern arrangement or a checkered pattern arrangement.

6. An information processing apparatus according to claim 4, wherein all the information displayed by the pixels of the liquid crystal display layer is the image displayed by the pixels corresponding to the first filter member, and the image displayed by the pixels corresponding to the second filter member.

7. An information processing apparatus comprising:
a display device including a liquid crystal display layer which decomposes an image into a plurality of pixel data, displays the image on a display screen as a group of pixel data, and outputs pixel data forming one display image and pixel data forming another display image in a specific arrangement on the same display screen as images, a filter layer disposed on a display side of the liquid crystal display layer and formed by alternately arranging a first filter member which blocks and transmits a light from a predetermined direction and a second filter member which blocks and transmits a light from a direction different from the predetermined direction, such that the filter members are arranged in a one-to-one correspondence with respective pixels of the liquid crystal display layer, and filter control means for controlling light block and transmission of the filter layer;
a display controller which controls display of the liquid crystal display layer;
a first filter memory which stores display information to be displayed by pixels corresponding to the first filter member;
a second filter memory which stores display information to be displayed by pixels corresponding to the second filter member; and
a video memory which temporarily stores the display information stored in the first filter memory and the display information stored in the second filter memory, and send the display information to the display controller as display information.

8. An information processing apparatus according to claim 7, wherein the direction different from the predetermined direction is a direction having a plane symmetry relationship with the predetermined direction.

9. An information processing apparatus according to claim 7, wherein the filter control means controls light block and transmission by applying a charge to the filter layer, and the display controller performs a control to display the respective images by the pixels corresponding to the first filter member and the pixels corresponding to the second filter member.

10. An information processing apparatus according to claim 9, wherein the filter layer transmits light from all the directions to display all the information displayed by the pixels of the liquid crystal layer, by performing control not to apply a charge to the filter layer by the filter control means.

11. An information processing apparatus according to claim 7, wherein the display device is formed by alternating the first filter member and the second filter member in a striped pattern arrangement or a checkered pattern arrangement.

12. An information processing apparatus according to claim 10, wherein all the information displayed by the pixels of the liquid crystal display layer is the image displayed by the pixels corresponding to the first filter member, and the image displayed by the pixels corresponding to the second filter member.

13. A display apparatus comprising:
a liquid crystal display layer which decomposes an image into a plurality of pixel data, displays the image on a display screen as a group of pixel data, and outputs pixel data forming one display image and pixel data forming another display image in a specific arrangement on the same display screen as images;
a filter layer disposed on a display side of the liquid crystal display layer and formed by alternately arranging a first filter member which blocks and transmits a light from a predetermined direction and a second filter member which blocks and transmits a light from a direction different from the predetermined direction, such that the filter members are arranged in a one-to-one correspondence with respective pixels of the liquid crystal display layer; and
filter control means for controlling light block and transmission of the filter layer,
wherein display information from a first filter memory connected to the apparatus is displayed by pixels corresponding to the first filter member and display information from a second filter memory connected to the apparatus is displayed by pixels corresponding to the second filter member, by control by the display controller.

14. A display apparatus according to claim 13, wherein the direction different from the predetermined direction is a direction having a plane symmetry relationship with the predetermined direction.
